(19) United States
(12) Patent Application Publication
(10) Pub. No.: US 2012/0267552 A1
(43) Pub. Date: Oct. 25, 2012

(54) OPTICAL METHOD AND SYSTEM FOR MODIFYING MATERIAL CHARACTERISTICS USING SURFACE PLASMON POLARITON PROPAGATION

(75) Inventors: Rosa A. Lukaszew, Williamsburg, VA (US); Cesar Clavero, Williamsburg, VA (US)

(73) Assignee: COLLEGE OF WILLIAM AND MARY, Williamsburg, VA (US)

(21) Appl. No.: 13/090,307

(22) Filed: Apr. 20, 2011

(51) Int. Cl. G21K 5/00

(52) U.S. Cl. 250/492.1

(57) ABSTRACT

A method and system modify a material's characteristics. A first material has at least one characteristic that changes in the presence of electromagnetic energy, and a second material is positioned such that it is in contact with the first material. The second material is electrically conductive and sustains Surface Plasmon Polariton (SPP) excitation and propagation when electromagnetic radiation is coupled thereto. A diffraction grating is disposed at a planar region defined by one of the second material and a composite of the first material and second material. A beam of electromagnetic radiation is directed towards the diffraction grating at an acute angle with respect to the planar region. The electromagnetic radiation incident on the diffraction grating is coupled to the second material whereby SPP propagation generates an electromagnetic wave incident on at least a portion of the first material to thereby change its characteristics.

### FIELD OF INVENTION

The field of the invention relates generally to systems and methods for modifying physical characteristics of materials, and more particularly to an optical method and system for modifying characteristics of a material using Surface Plasmon Polariton (SPP) propagation.

### BACKGROUND OF THE INVENTION

Surface Plasmon Polaritons (SPPs) are transverse magnetic surface waves propagating at the surface of an electrical conductor. SPPs result from interactions between illuminating radiation and the free electrons of the conductor. The propagating SPPs generate highly-confined electromagnetic fields. Initiating and controlling SPP propagation is an emerging field that has potential value in various electronic and optical solid-state applications where application results typically rely on changes in material characteristics. However, to date, simple methods and systems that use SPP initiation/propagation to control material properties for a broad variety of applications are not available.

### BRIEF SUMMARY OF THE INVENTION

Accordingly, it is an object of the present invention to provide a method and system for modifying a material's characteristics using SPPs.

Another object of the present invention is to provide a simple method and system for modifying material characteristics using SPPs where the method/system can be applied to a broad range of applications.

In accordance with the present invention, a system and method are provided for modifying a material's characteristics. A first material has at least one characteristic that changes in the presence of electromagnetic energy, and a second material is positioned such that it is in contact with the first material. The second material is electrically conductive and sustains Surface Plasmon Polariton (SPP) excitation and propagation when electromagnetic radiation is coupled thereto. A planar region is defined by one of the second material and a composite of the first material and second material. A diffraction grating is disposed at the planar region. A source directs a beam of electromagnetic radiation towards the diffraction grating at an acute angle with respect to the planar region. The electromagnetic radiation incident on the diffraction grating is coupled to the second material. As a result, the SPP propagation generates an electromagnetic wave incident on at least a portion of the first material to thereby change its characteristics.

### BRIEF DESCRIPTION OF THE DRAWINGS

The summary above, and the following detailed description, will be better understood in view of the drawings that depict details of preferred embodiments.

FIG. 1 is a schematic view of a system for modifying a material's characteristics in accordance with an embodiment of the present invention;

FIG. 2 is a plan view of a diffraction grating schematically illustrating the orientation of the beam of electromagnetic radiation used to initiate the propagation of Surface Plasmon Polaritons (SPPs) in accordance with an embodiment of the present invention;

FIG. 3 is a schematic view of a system for modifying a material's characteristics in accordance with another embodiment of the present invention;

FIG. 4 is a schematic view of a system that modifies the characteristics of a magnetic data storage media for the purpose of reading the stored data in accordance with another embodiment of the present invention;

FIG. 5 is a schematic view of a system that modifies the characteristics of a magnetic material for the purpose of sensing the presence of a material-of-interest in accordance with another embodiment of the present invention;

FIG. 6 is a schematic view of a system that modifies the characteristics of a magnetic material in a patterned fashion for the purpose of defining a plasmonic circuit in accordance with another embodiment of the present invention;

FIG. 7 is a schematic view of a system that modifies the characteristics of an optical waveguide for the purpose of changing the optical modulation properties thereof in accordance with another embodiment of the present invention; and

FIG. 8 is a schematic view of a system for modifying a material's characteristics in accordance with yet another embodiment of the present invention.

### DETAILED DESCRIPTION OF THE INVENTION

The present invention is a simple method and system for modifying the propagation of Surface Plasmon Polaritons (SPPs). As will be explained later herein, the method and system can be used in a variety of applications to include reading of magnetically-stored data, sensing, plasmonic circuits, and optical modulation in waveguides. Prior to describing these various applications, the essential principles and elements of the method and system, respectively, will be presented.

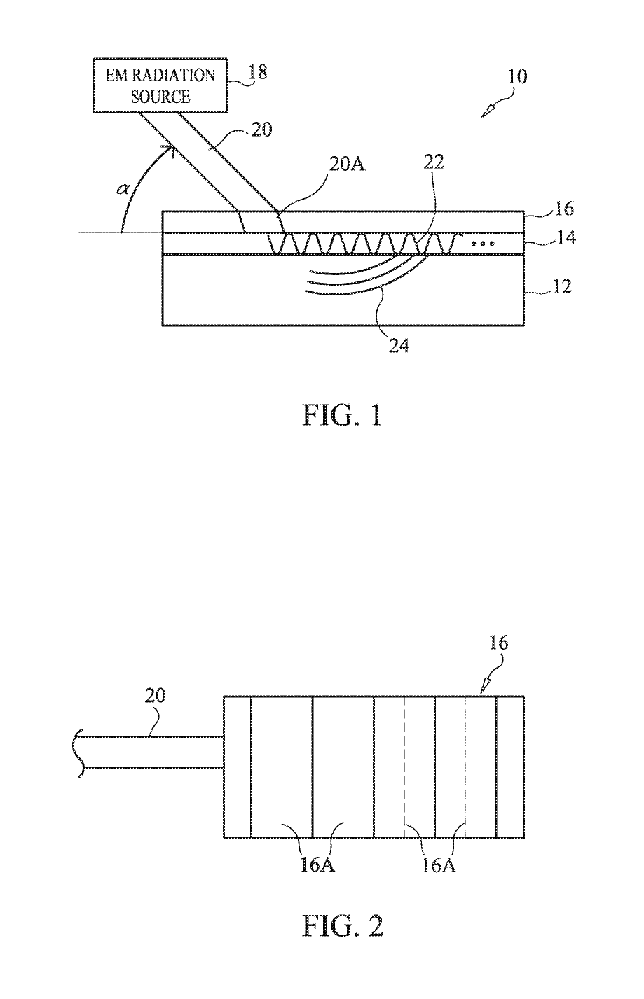

Referring now to the drawings and more particularly to FIG. 1, an embodiment of an optical system for modifying one or more characteristics of a material is shown and is referenced generally by numeral 10. It is to be understood that the shapes of the elements of system 10 and relative sizes of the elements of system 10 (as well as other embodiments described herein) are for purpose of illustration only and are not to scale. System 10 includes a material 12 having one or more properties or characteristics that are subject to change when material 12 is partially or fully exposed to electromagnetic energy. The particular properties or characteristics that are subject to change depend on the particular material 12, the choice of which is dependent upon the ultimate application of system 10. Typical properties or characteristics that change in the presence of electromagnetic energy include magnetic properties, ferroelectric properties, optical properties, and magneto-optical properties. Accordingly, material 12 is typically a magnetic, ferroelectric, or optical material.

Another material 14 is placed in contact with material 12. Typically, material 14 is formed as a layer on a surface of material 12. Materials 12 and 14 can be adhered or bonded to one another with the particular bonding technique being predicated on the particular materials 12 and 14. Such bonding techniques are well known in the art and are not limitations of the present invention. In most applications, material 14 is formed as a thin-film (i.e., on the order of approximately one micron or less) along a planar surface of material 12 such that material 14 forms a planar, thin-film. Note that material 12 can be a thin-film or bulk material without departing from the scope of the present invention. For purpose of the present invention, material 14 is an electrically conductive material and is capable of sustaining SPP excitation and propagation when electromagnetic radiation is coupled to material 14. The wavelength of the electromagnetic radiation is selected based on the particular material 14 as well as the application's requirements.

A diffraction grating 16 is provided at some or all of the surface (i.e., a planar surface) of material 14. Diffraction grating 16 can be formed directly in material 14 or could be a separate element that is coupled to material 14. As is known in the art, diffraction gratings are defined by diffraction features such as parallel grooves or periodic arrays of geometric patterns such as squares, rectangles, etc., that cause any electromagnetic radiation incident thereon to diffract in some known way. The particulars of diffraction grating 16 can be tailored to a specific application of system 10.

System 10 also includes an electromagnetic (EM) radiation source 18 capable of producing a beam 20 of EM radiation having a wavelength selected for a particular application. For example, suitable wavelengths include those in the visible, ultraviolet, and infrared spectrums. Beam 20 is directed towards grating 16 to be incident thereon whereby diffracted EM radiation 20A propagates to material 14. For purposes of the present invention, the angle of incidence a that beam 20 makes with the planar surface of material 14 is an acute angle (i.e., 0°<α<90°). Further and as illustrated schematically in FIG. 2, although not a strict requirement, beam 20 is generally oriented to be perpendicular (or approximately so) to parallel grooves (represented by dashed lines 16A) formed/defined by diffraction grating 16. If beam 20 is not perpendicular to grooves 16A, conical diffraction will result whereby diffraction orders of diffraction grating 16 will change and the intensity of the diffracted EM radiation will decrease. Accordingly, changing the orientation of beam 20 relative to parallel grooves 16A can be used as a means to adjust the results produced by the diffracted EM radiation. If diffraction grating 16 is realized by a periodic array of geometric patterns, beam 20 could be oriented to be perpendicular to a particular “line” of the geometric patterns.

The combination of material 14, diffraction grating 16, and source 18 are selected to excite and propagate SPPs along material 14 as illustrated by wavy line 22. As a result, an electromagnetic (EM) wave 24 is generated that is incident on material 12. The energy associated with EM wave 24 changes one or more characteristics of material 12 in some known way to satisfy the requirements of a particular application of system 10. The portion of material 12 subjected to the effects of EM wave 24 can be controlled by one or more of the choices of material 14, diffraction grating 16, and source 18, as well as the location of diffraction grating 16 as will be explained further below.

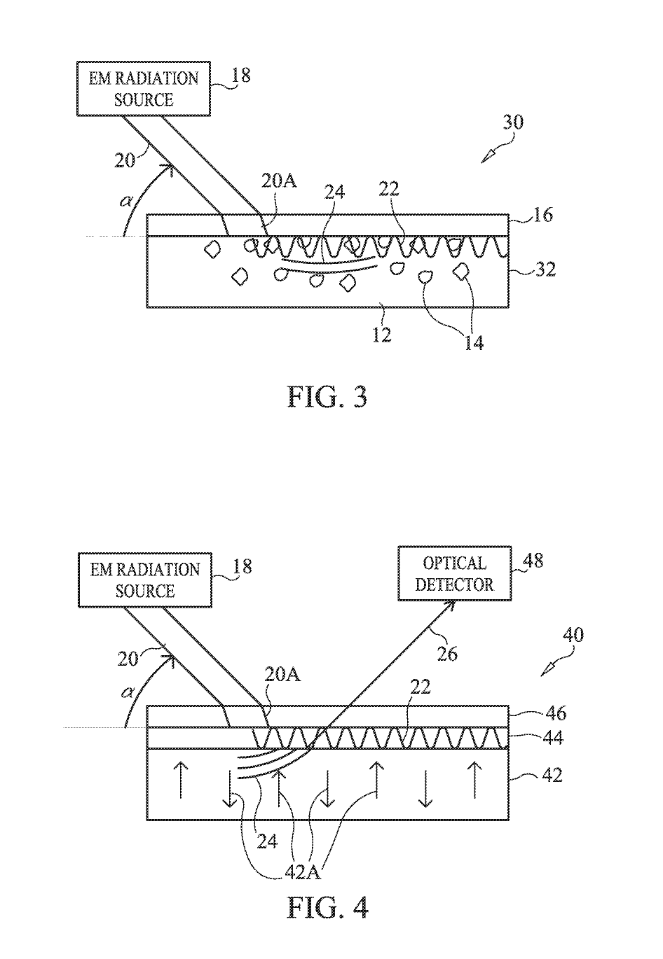

Another embodiment of the present invention is illustrated in FIG. 3 where elements common to those previously described herein utilize the same reference numerals. In system 30, materials 12 and 14 are combined into a composite material 32 whereby the above-described properties of material 12 and material 14 are retained and exhibited by composite material 32. As in the previous embodiment, composite material 32 presents a planar surface at which diffraction grating 16 is coupled to or formed directly therein. Composite material 32 can be in the form of a thin-film whose thickness will generally not exceed approximately one micron. EM source 18 illuminates diffraction grating 16 with beam 20 at acute angle α whereby the diffracted radiation 20A is coupled to material 14. Once this occurs, SPP excitation and propagation 22 is sustained and EM wave 24 is generated/incident on some or all of material 12 resident in composite material 32. The resultant characteristic changes in material 12 are used by system 20 in accordance with a particular application.

As mentioned above, the present invention can be adapted for a variety of applications. While some exemplary applications will now be described with the aid of FIGS. 4-7, it is to be understood that additional applications fall within the scope of the present invention. Each application is explained using separate (layers) for materials that are analogous to materials 12 and 14. However, the present invention is not so limited as applications might also be practiced using a composite form of materials 12 and 14.

FIG. 4 illustrates a system 40 for reading stored magnetic data. In this application, it is assumed that a magnetic material 42 (e.g., magnetic metals, magnetic alloys, etc.) has a number of magnetic bit states (represented by arrows 42A) “written” therein as would be well understood in the art of magnetic data storage. A material 44 analogous to previously-described material 14 is provided on a planar surface of material 42. Suitable materials for material 44 include, but are not limited to, gold and silver. Typically, material 44 is in the form of a thin-film (approximately one micron or less in thickness) bonded to material 42. Diffraction grating 46 is coupled to material 44 or is incorporated directly therein. Similar to the previous embodiments, EM radiation source 18 directs beam 20 to be incident on diffraction grating 46 at acute angle α. The diffracted EM radiation 20A is coupled to material 44 whereby SPPs 22 are excited/propagated such that EM wave 24 is incident on magnetic (data storage) material 42. EM wave 24 enhances the magneto-optical activity property of magnetic material 42. That is, exposure of magnetic material 42 to EM wave 24 increases the optical sensitivity of magnetic states 42A. Accordingly, system 40 is configured to confine the production of EM wave 24 to a specified region of magnetic material 42 in order to “read” magnetic bit states 42A in the specified region. Reading of magnetic states 42A is accomplished using an optical detector 48 capable of detecting EM radiation 26 that reflects off magnetic material 42 and propagates through material 44 and diffraction grating 46. Detector 48 should be able to detect the radiation's intensity and polarization state to determine bit state.

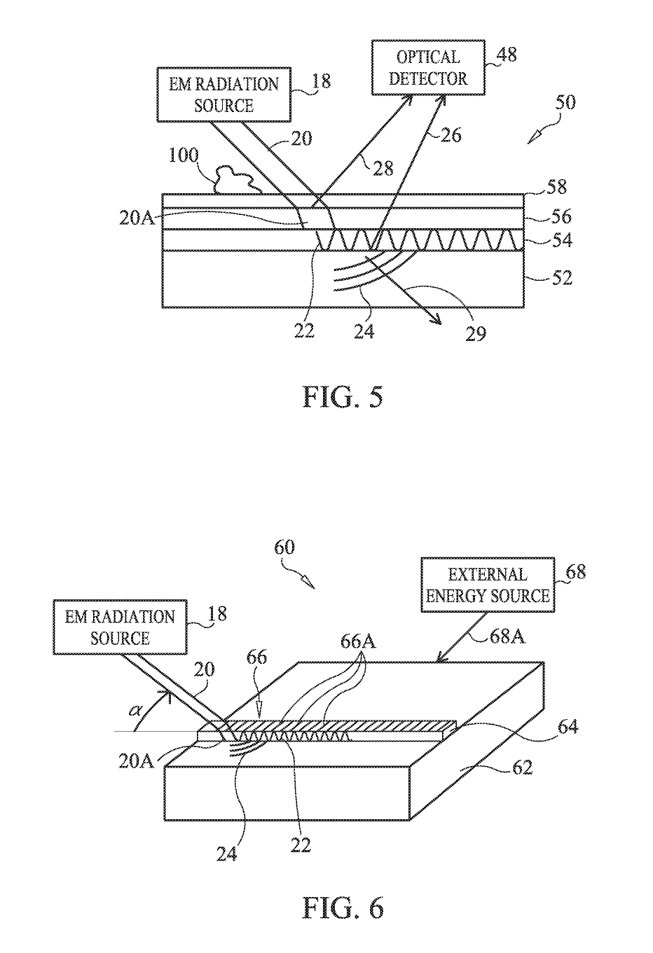

Referring now to FIG. 5, a system 50 is configured for sensing the presence of a material-of-interest (e.g., a gas, particles of a substance, biomolecules, etc.). In this application, a magnetic material 52 (e.g., magnetic metal, magnetic alloy, etc.) is used to increase the sensitivity of system 50 to a particular material of interest. A material 54 (e.g., gold, silver, etc.) analogous to previously-described material 14 is provided on a planar surface of magnetic material 52. Once again, material 54 will typically be a thin-film (approximately one micron or less in thickness) bonded to material 52. Diffraction grating 56 is coupled to material 54 or is incorporated directly therein. Deposited on the surface of diffraction grating 56 is a reactive material 58 (e.g., a thin-film, spray coating, etc.) selected to react (e.g., bond) with some material-of-interest 100 that could be present in the environment where system 50 will be used. When material-of-interest 100 is not present, diffraction grating 56 will diffract beam 20 (from EM radiation source 18) in a known fashion. When material-of-interest 100 is present, it will react with material 58 to thereby alter the diffraction of beam 20 incident on diffraction grating 56 based on the reaction of material 58 with material-of-interest 100. System 50 is designed such that, when material-of-interest 100 is present, diffracted beam 20A causes changes in SPPs 22 when EM wave 24 is incident on material 52. Magneto-optical properties of material 52 are enhanced by SPPs and can be modulated by application of modest (e.g., less than a few hundred oersted) external oscillating magnetic field thereby increasing the signal-to-noise ratio (at optical detector 48) of EM radiation 26 reflecting off material 52. In this application, detector 48 could additionally or alternatively be sensitive to EM radiation 28 diffracting directly from diffraction grating 56 since its diffraction orders will be altered when material-of-interest 100 is present. A detector (not shown) could also be positioned to measure EM radiation 29 transmitted through material 52 where such transmission is altered when material-of-interest 100 is present.

FIG. 6 illustrates a system 60 that is configured as a plasmonic circuit. In this application, a magnetic, ferroelectric, or optical material 62 has a material 64 (analogous to previously-described material 14) formed as a pattern thereon. In this embodiment, some suitable materials 62 could be, but are not limited to, cobalt, iron and vanadium dioxide. Suitable materials 64 include, but are not limited to, gold, silver, and conducting transparent oxides. Material 64 is typically a thin-film having a thickness of approximately one micron or less. Diffraction grating 66 is coupled to or incorporated in patterned material 64. EM radiation source 18 directs beam 20 to be incident on diffraction grating 66 at acute angle α. Beam 20 is also typically perpendicular to the diffraction grating's parallel grooves (represented by straight lines 66A). Diffracted EM radiation 20A is coupled to patterned material 64 whereby SPPs 22 and the resulting EM wave follow or track along with patterned material 64. In this application, material 62 can also modify SPPs 22 in terms of the SPP's propagation distance and wavelength. Accordingly, it may also be desirable to provide an external energy source 68 (e.g., magnetic field source, thermal source, electric field source, etc.) that can couple energy 68A to material 62 in order to alter the magnetic properties thereof.

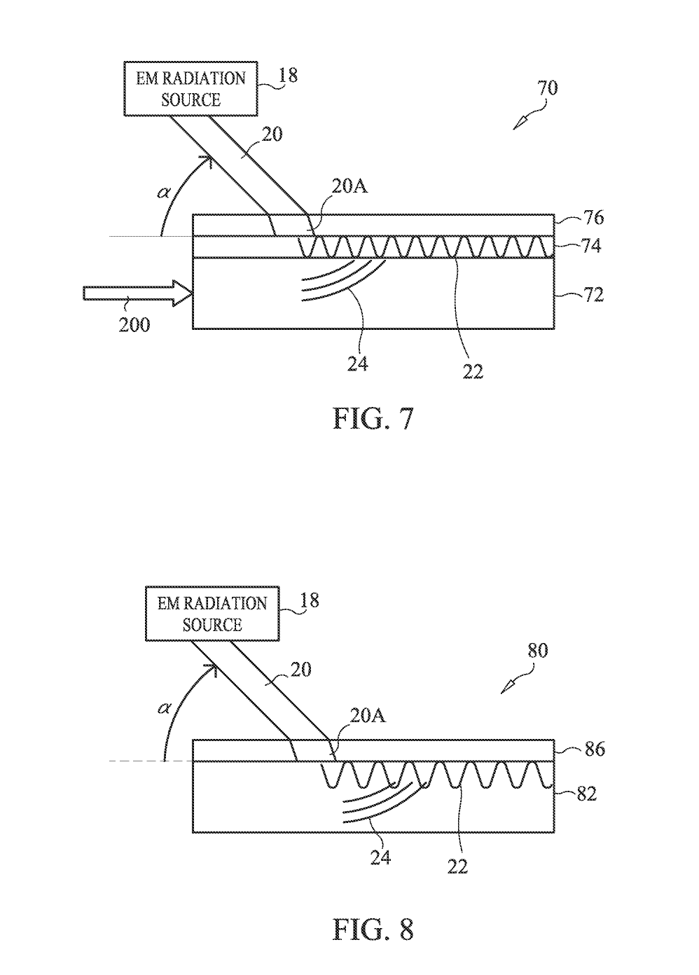

Referring now to FIG. 7, system 70 illustrates an optical application of the present invention where an optical material 72 defines a portion of a waveguide used to transmit optical energy 200. A material 74 (analogous to previously-described material 14) is in contact with waveguide material 72. For example, material 74 could be a thin-film (thickness of approximately one micron or less) cladding on waveguide material 72. Diffraction grating 76 is coupled to or incorporated in material 74. EM radiation source 18 directs beam 20 to be incident on diffraction grating 76 at acute angle α. Diffracted radiation 20A is coupled to material 74 whereby SPPs 22 are excited/propagated and EM wave 24 is thereby generated. Optical properties of waveguide material 72 are modified by EM wave 24 thereby modifying the electromagnetic modes that can be transmitted through waveguide material 72.

While the various applications of the present invention described thus far assume the use of disparate materials (i.e., analogous to materials 12 and 14), the present invention is not so limited. For example, system 80 in FIG. 8 illustrates an embodiment of the present invention using a single (thin-film) material 82 that is electrically conductive, sustains SPP excitation/propagation when EM radiation is coupled thereto, and possesses characteristics that are changeable in the presence of electromagnetic energy. For example, material 82 could be nickel, or a variety of magnetic alloys. A diffraction grating 86 can be coupled to or incorporated in the planar surface of material 82. EM radiation source 18 directs beam 20 to be incident on diffraction grating 86 as in the previous embodiments.

The advantages of the present invention are numerous. A simple and efficient method of SPP excitation/propagation is used to modify the characteristics of a material. The basic elements of the system/method can be readily adapted to a variety of electronic and optical applications.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

We claim:

1. A system for modifying a material's characteristics, comprising:
a first material having at least one characteristic that changes in the presence of electromagnetic energy;
a second material in contact with said first material, said second material being electrically conductive and sustaining Surface Plasmon Polariton (SPP) excitation and propagation when electromagnetic radiation is coupled thereto;
a planar region defined by one of said second material and a composite of said first material and said second material;
a diffraction grating at said planar region; and
a source for directing a beam of said electromagnetic radiation towards said diffraction grating at an acute angle with respect to said planar region, wherein said electromagnetic radiation incident on said diffraction grating is coupled to said second material and wherein said SPP propagation generates an electromagnetic wave incident on at least a portion of said first material.

2. A system as in claim 1, wherein said second material comprises a layer thereof on said first material.

3. A system as in claim 1, wherein said one of said second material and said composite comprises a film.

4. A system as in claim 3, wherein thickness of said film does not exceed approximately one micron.

5. A system as in claim 1, wherein said diffraction grating is formed at said planar region from said one of said second material and said composite.

6. A system as in claim 1, wherein said diffraction grating is coupled to said one of said second material and said composite at said planar region.

7. A system as in claim 1, wherein said first material is selected from the group consisting of a magnetic material, a ferroelectric material, and an optical material.

8. A system as in claim 1, further comprising a detector for detecting intensity and polarization of a portion of said electromagnetic radiation experiencing one of diffraction caused by said diffraction grating, reflection from said first material, and transmission through said first material.

9. A system as in claim 1, further comprising a third material on said diffraction grating, said third material being adapted to react with a material-of-interest wherein optical properties of said diffraction grating are altered.

10. A system as in claim 9, further comprising a detector for detecting intensity and polarization of a portion of said electromagnetic radiation experiencing one of diffraction caused by said diffraction grating, reflection from said first material, and transmission through said first material.

11. A system as in claim 1, wherein said second material forms a pattern on said first material.

12. A system as in claim 11, wherein said second material comprises a film having a thickness that does not exceed approximately one micron.

13. A system as in claim 1, wherein said first material and said second material are identical.

14. A system for modifying a material's characteristics, comprising:
a first material selected from the group consisting of a magnetic material, a ferroelectric material, and an optical material, said first material having at least one characteristic that changes in the presence of electromagnetic energy;
a second material in contact with said first material, said second material being electrically conductive and sustaining Surface Plasmon Polariton (SPP) excitation and propagation when electromagnetic radiation is coupled thereto;
a film defined by one of said second material and a composite of said first material and said second material;
a diffraction grating at a surface of said film; and
a source for directing a beam of said electromagnetic radiation towards said diffraction grating at an acute angle with respect to said surface of said film, wherein said electromagnetic radiation incident on said diffraction grating is coupled to said second material and wherein said SPP propagation generates an electromagnetic wave incident on at least a portion of said first material.

15. A system as in claim 14, wherein said second material comprises a layer thereof on said first material.

16. A system as in claim 14, wherein thickness of said film does not exceed approximately one micron.

17. A system as in claim 14, wherein said diffraction grating is formed in said film.

18. A system as in claim 14, wherein said diffraction grating is coupled to said film.

19. A system as in claim 14, wherein a portion of said electromagnetic radiation passes through said second material and is incident on said first material, said system further comprising a detector for detecting intensity and polarization of said portion of said electromagnetic radiation experiencing one of diffraction caused by said diffraction grating, reflection from said first material, and transmission through said first material.

20. A system as in claim 14, further comprising a third material on said diffraction grating, said third material being adapted to react with a material-of-interest wherein optical properties of said diffraction grating are altered.

21. A system as in claim 20, wherein a portion of said electromagnetic radiation passes through said second material and is incident on said first material, said system further comprising a detector for detecting intensity and polarization of said portion of said electromagnetic radiation experiencing one of diffraction caused by said diffraction grating, reflection from said first material, and transmission through said first material.

22. A system as in claim 14, wherein said film comprises said second material formed as a pattern on said first material.

23. A system as in claim 14, wherein said first material and said second material are identical.

24. A method of modifying a material's characteristics, comprising the steps of:
positioning a first material in contact with a second material, the first material having at least one characteristic that changes in the presence of electromagnetic energy and the second material being electrically conductive and sustaining Surface Plasmon Polariton (SPP) excitation and propagation when electromagnetic radiation is coupled thereto;
disposing a diffraction grating at a planar region of one of the second material and a composite of the first material and the second material; and
directing a beam of the electromagnetic radiation towards the diffraction grating at an acute angle with respect to the planar region, wherein the electromagnetic radiation incident on the diffraction grating is coupled to the second material and wherein said SPP propagation generates an electromagnetic wave incident on at least a portion of the first material.

25. A method according to claim 24, wherein said step of positioning comprises the step of forming the second material as a film not to exceed approximately 1 micron in thickness on the first material.

26. A method according to claim 24, wherein said step of disposing comprises the step of forming the diffraction grating from one of the second material and the composite.

27. A method according to claim 24, wherein said step of disposing comprises the step of coupling the diffraction grating to one of the second material and the composite.

28. A method according to claim 24, wherein the first material is selected from the group consisting of a magnetic material, a ferroelectric material, and an optical material.

29. A method according to claim 24, further comprising the step of detecting intensity and polarization of a portion of the electromagnetic radiation experiencing one of diffraction caused by the diffraction grating, reflection from the first material, and transmission through the first material.

30. A method according to claim 24, wherein said step of positioning comprises the step of forming the second material as a pattern on the first material.

31. A method according to claim 24, wherein the diffraction grating defines diffraction features, and wherein said step of directing comprises the step of orienting the beam to be approximately perpendicular to at least a portion of the diffraction features.

32. A method according to claim 24, further comprising the step of depositing a third material on the diffraction grating, the third material being adapted to react with a material-of-interest wherein optical properties of the diffraction grating are altered.

33. A method according to claim 32, further comprising the step of detecting intensity and polarization of a portion of the electromagnetic radiation experiencing one of diffraction caused by the diffraction grating, reflection from the first material, and transmission through the first material.

34. A method according to claim 24, wherein the first material and the second material are identical.
